(19) United States
(12) Patent Application Publication
(10) Pub. No.: US 2012/0121140 A1
(43) Pub. Date: May 17, 2012

(54) Leveraging Real-Time Biometric Recognition Software in Software Systems Management

(75) Inventor: John Kenyon Gerken, III, Apex, NC (US)

(73) Assignee: International Business Machines Corporation, Armonk, NY (US)

(21) Appl. No.: 12/945,780

(22) Filed: Nov. 12, 2010

(51) Int. Cl. G06K 9/00

(52) U.S. Cl. 382/115

(57) ABSTRACT

An approach is presented that establishes an authorized user identity at an information handling system. The user is permitted access to the information handling system after which the user's expected biometric data is retrieved from a data store. The system repeatedly receives biometric input (e.g., facial image) with the biometric input corresponding to a current user of the system. If the biometric data corresponding to the current user of the system matches the expected biometric data, then the user is allowed continued access to the system. On the other hand, if the biometric data corresponding to the current user of the system does not match the expected biometric data then access to the system is inhibited.

### TECHNICAL FIELD

The present invention analyzes biometric data to allow a user continued access to a software application. More particularly, the present invention repeatedly ensures that an authorized user is the current user of a software application using biometric sensors, such as digital cameras.

### BACKGROUND

Identifying computer system users based on biometric features, such as facial recognition, is becoming more ubiquitous in modern systems. Digital data is derived based upon a biometric input, such as a facial image, fingerprint scan, or iris scan, etc. This digital data is compared with data previously stored in a data store, such as a database, to determine if the digital data matches an individual whose biometric data is stored in the data store. In the realm of facial recognition, some facial recognition algorithms identify faces by extracting landmarks, or features, from an image of the subject's face. These landmarks may include the relative position, size, and/or shape of the eyes, nose, cheekbones, and jaw. These features are then used to search for other images with matching features. Other facial recognition algorithms normalize a gallery of face images and then compress the face data so that only the data that is useful for face detection is saved. A probe image is then compared with the face data. Recognition algorithms can be divided into two main approaches, geometric, which looks at distinguishing features, and photometric, which is a statistical approach that distills an image into values and comparing the values with templates to eliminate variances. Similar approaches might be used in gathering and comparing other biometric data, such as using fingerprint scans and iris scans.

### SUMMARY

An approach is presented that establishes an authorized user identity at an information handling system. The user is permitted access to the information handling system after which the user's expected biometric data is retrieved from a data store. The system repeatedly receives biometric input (e.g., facial image) from biometric sensors. The biometric input that is received corresponds to a current user of the system. If the biometric data corresponding to the current user of the system matches the expected biometric data, then the user is allowed continued access to the system. On the other hand, if the biometric data corresponding to the current user of the system does not match the expected biometric data then access to the system is inhibited.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 is a network diagram of various types of data processing systems connected via a computer network;

FIG. 3 is a block diagram depicting the components used in using real-time biometric recognition in software systems management;

FIG. 4 is a flowchart depicting a continuous verification process used to repeatedly verify the identity of a user of a software system;

FIG. 5 is a flowchart depicting a sub-process used to detect presence of a still image that might be used in an attempt to circumvent the continuous verification process; and

FIG. 6 is a flowchart depicting gathering biometric data used to set up, or initialize, the continuous verification process.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

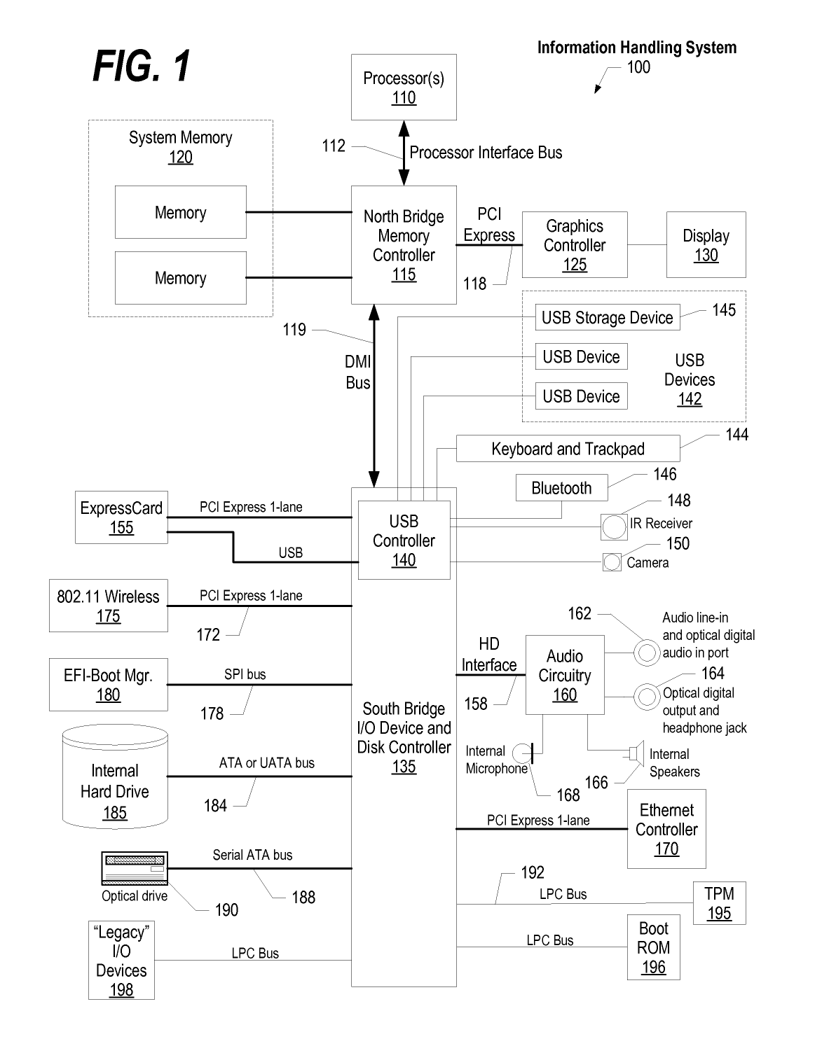

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

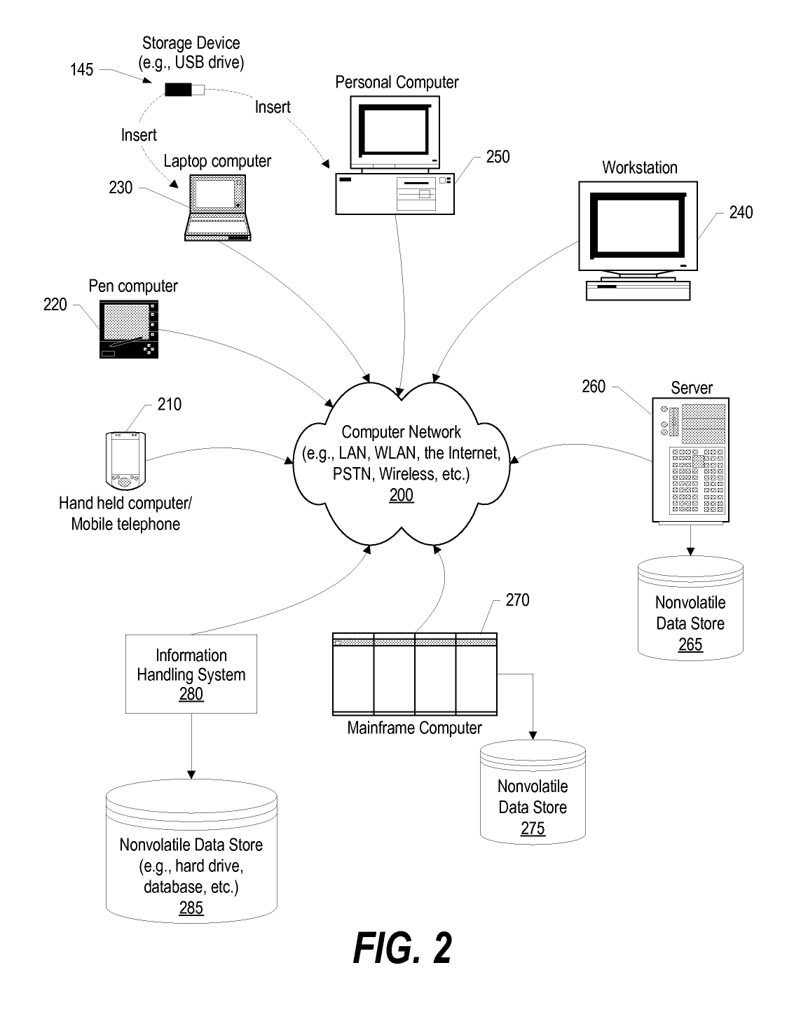

FIG. 2 is a network diagram of various types of data processing systems connected via a computer network. FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

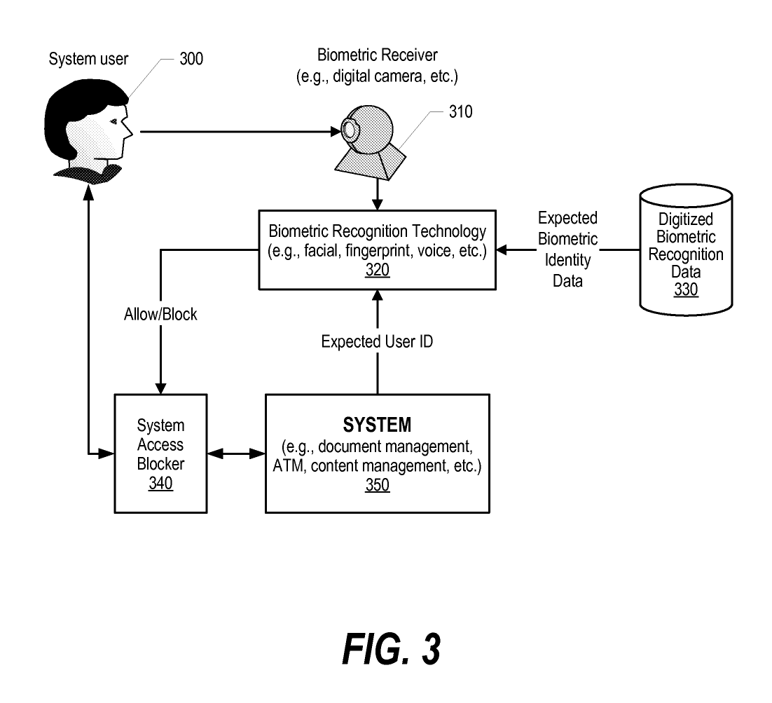

FIG. 3 is a block diagram depicting the components used in using real-time biometric recognition in software systems management. System user 300 is an authorized user of information handling system 350, such as an automatic teller machine (ATM), document management system, web-based application (such as a web content filtering application), and any other shared system where individuals are authorized to access the system. Biometric receiver 310, such as the shown digital camera, is used to receive biometric input corresponding to the current user (e.g., the user that is actually using the system which may not be the same as the authorized user that initiated the session). Biometric recognition technology 320, such as facial recognition technology, is used to compare the biometric input (e.g., facial image) with expected biometric data retrieved from data store 330, such as a data store that is used to store facial images of authorized users.

Once the authorized user's identity is established, the user is allowed access to information handling system 350. Meanwhile, biometric recognition technology 320 repeatedly receives biometric input from biometric receiver 310. If the authorized user moves away from the system, then biometric recognition technology 320 provides a block signal to system access blocker module 340 which is used to block, or inhibit, access to the system when the authorized user's presence cannot be verified. In one embodiment, access to the system is suspended while the system waits for the authorized user to return. If the authorized user does not return within a given timeframe, then the user's session with the information handling system is terminated. However, if the user returns to the system so that expected biometric input can be received (e.g., the facial image of the authorized user), then the session is resumed. In one embodiment, the system is configured to check for multiple individuals that are possibly viewing the contents of the display screen included in the information handling system. In a further embodiment, the authorized user may be asked whether processing should be suspended if any of the individuals detected by the biometric receiver (e.g., digital camera, etc.) are not authorized users. In a different embodiment, such as where data sensitivity is paramount, the system could suspend operations if any non-authorized users are detected.

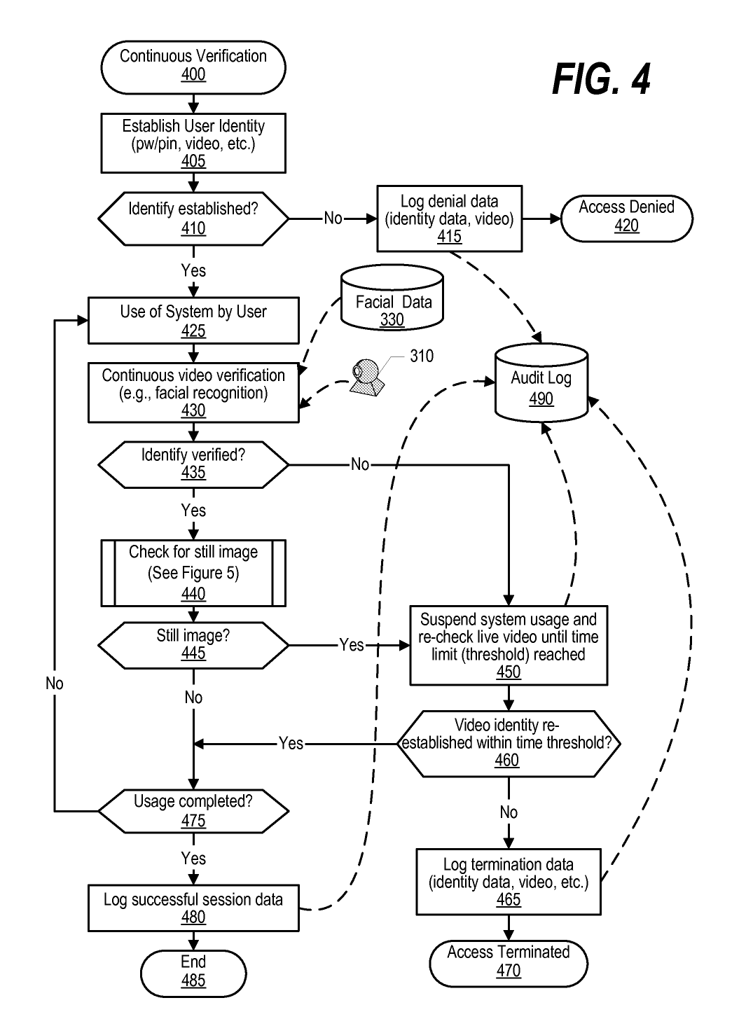

FIG. 4 is a flowchart depicting a continuous verification process used to repeatedly verify the identity of a user of a software system. Processing commences at 400 whereupon, at step 405, an authorized user's identity is established at the information handling system (e.g., using a user identifier and password, providing biometric input, etc.). A decision is made as to whether identification of an authorized user has been established (decision 410). If identification of an authorized user has not been established, then decision 410 branches to the “no” branch whereupon, at step 415, the denial data, such as the invalid user identifier/password, invalid biometric data, etc.) is logged (recorded) to a nonvolatile memory, such as audit log 490. Processing thereafter ends at 420 with access to the system being denied to the user.

On the other hand, if identification of an authorized user was established in step 405, then decision 410 branches to the “yes” branch whereupon, at step 425 the user commences use of the information handling system. At step 430, the system retrieves the expected biometric data from data store 330 with the expected biometric data corresponding to the authorized user identity established in step 405 and compares the expected biometric data with current biometric data being received from biometric receiver 310, such as a digital camera, fingerprint reader, voiceprint reader, etc. A decision is made as to whether the expected biometric data matches the current biometric data being received from the biometric receiver (decision 435). The system repeatedly receives and processes biometric input, such as receiving facial images of the user via a digital camera, to determine if the user is still using the system as shown in steps 440 through 485.

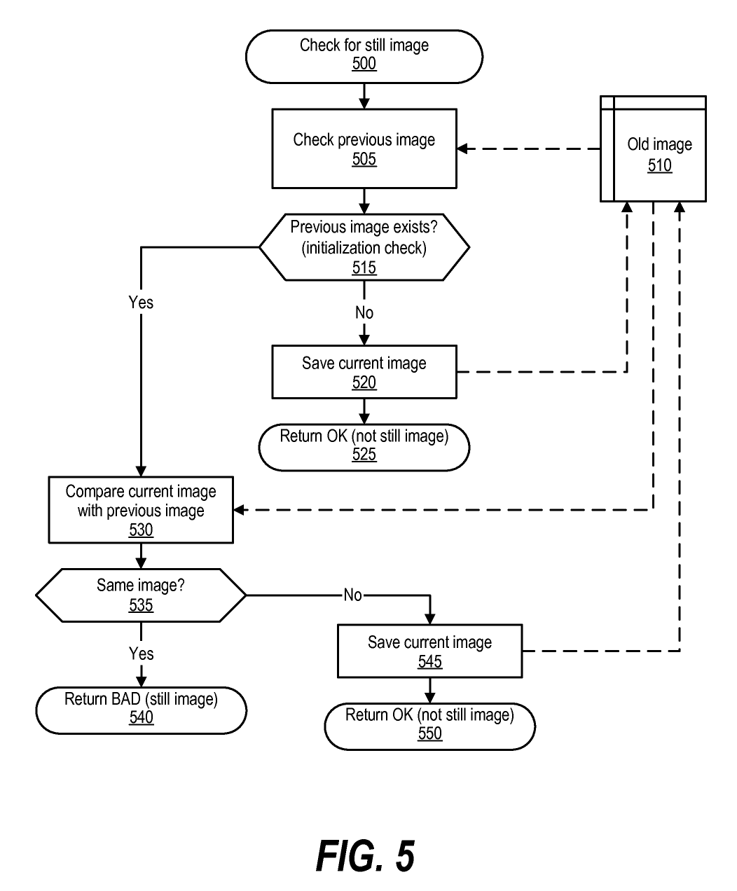

If the current biometric data matches the expected biometric data, then decision 435 branches to the “yes” branch whereupon (in a system employing facial recognition as the biometric input) at predefined process 440, a check is made to ensure that a still image is not being used in an effort to thwart the system's identity verification process (see FIG. 5 and corresponding text for processing details). A decision is made as to whether a still image is being used (decision 445). If either (a) a still image is being used, or (b) the user's identity was not verified in decision 435, then processing branches to step 450 whereupon the user's access to the system is suspended. In one embodiment, as discussed above with reference to FIG. 3, if multiple individuals are detected and each of the detected users are not authorized users, then the system branches from decision 435 to the “no” branch to prevent unauthorized users from accessing the system. In another embodiment, decision 435 branches to the “no” branch when no one is detected proximate to the system (e.g., the authorized user steps away from the system, etc.). While user access is suspended, access to the information handling system by the user is inhibited, however the system continues to receive biometric input and compare to expected biometric data in order to determine if the user has returned to the system. In one embodiment, when access to the system is suspended, data is written to audit log 490 (e.g., timestamp of suspension, current biometric input such as facial image, etc.). Access is suspended while the current biometric input is repeatedly compared against the expected biometric data. A decision is made as to whether the user has returned to the system (current biometric input matching expected biometric data) before a given time limit has elapsed (decision 460). If the user identity is re-established before the time limit has elapsed, then decision 460 branches to the “yes” branch and access to the system by the user is resumed. On the other hand, if the time limit elapses before the user's identity is re-established using the biometric input, then decision 460 branches to the “no” branch whereupon, at step 465, termination data is logged to audit log 490 (e.g., the timestamp, current biometric input, such as the current facial image, etc.). Access to the system is then terminated at 470.

If the user's identity is verified and a still image is not detected, then decision 445 branches to the “no” branch whereupon the user continues to use the system without interruption. A decision is made as to whether the user's use of the system is completed (decision 475), which might be signaled by the user logging off, etc. If the user's use of the system is not completed, then decision 475 branches to the “no” branch which loops back to repeatedly receive current biometric input (e.g., facial images, etc.) to ensure that the authorized user is still using the system. This looping continues until either the user is no longer detected at the system (decision 435 branching to the “no” branch), a still image is detected (decision 445 branching to the “yes” branch), or the user's use of the information handling system is completed (decision 475 branches to the “yes” branch). When the user's use of the information handling system is completed, decision 475 branches to the “yes” branch whereupon, at step 480, successful session data is written to audit log 490 (e.g., timestamp, biometric input data, etc.). Processing thereafter ends at 485.

FIG. 5 is a flowchart depicting a sub-process used to detect presence of a still image that might be used in an attempt to circumvent the continuous verification process. Processing commences at 500 when this process is called from predefined process 440 shown in FIG. 4. At step 505, a check is made of a previous digital image of the user's face that was taken by the digital camera and stored in memory 510. A decision is made as to whether the previous image exists, to identify if the process is being initialized (decision 515). If the previous image does not exist, then decision 515 branches to the “no” branch whereupon, at step 520, the current biometric input (e.g., facial image) is saved to memory 510 and processing returns to the calling routine at 525 with a return code indicating that a still image was not detected.

Returning to decision 515, if a previous image is detected, then decision 515 branches to the “yes” branch whereupon, at step 530, the current biometric data (e.g., the user's current facial image) is compared to the previously stored image. A decision is made as to whether the exact same image is being used (decision 535), indicating use of a still photograph or image by someone attempting to thwart the system's safeguards. If the same image is detected, then decision 535 branches to the “yes” branch whereupon, at step 540 processing returns to the calling routine with a return code indicating that a still image was detected which will cause use of the system to be suspended, as shown in FIG. 4. On the other hand, if a still image was not detected, then decision 535 branches to the “no” branch whereupon, at step 545 the current biometric input (e.g., the user's current facial image) is stored to memory 510. Processing then returns to the calling routine at 550 with a return code indicating that a still image was not detected.

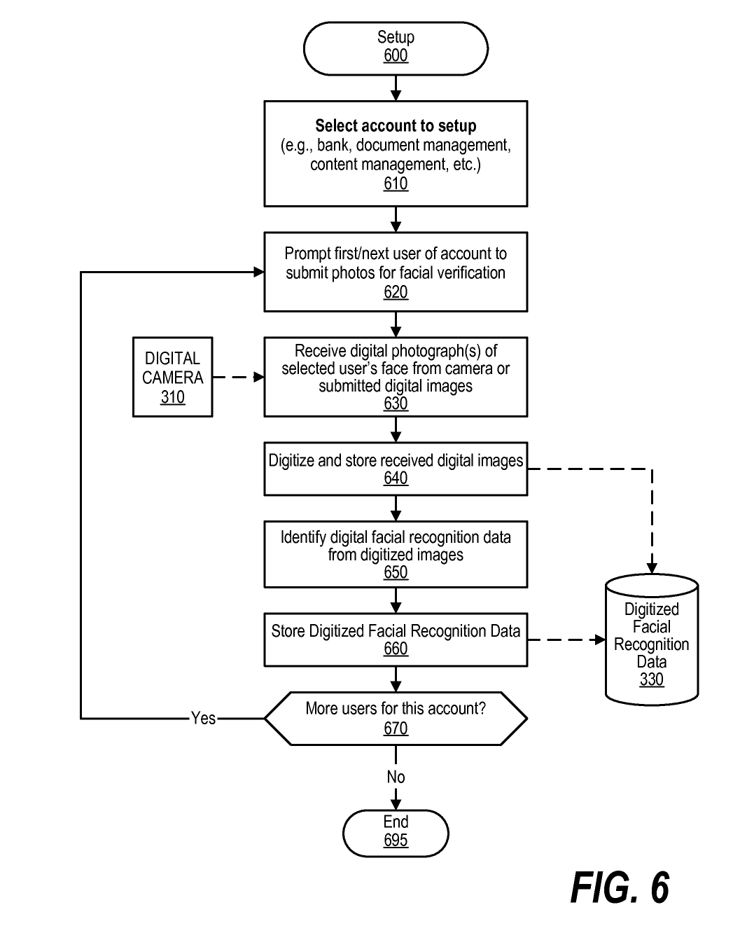

FIG. 6 is a flowchart depicting gathering biometric data used to set up, or initialize, the continuous verification process. Processing commences at 600 whereupon, at step 610, the user selects an account to setup (e.g., a bank account used with an ATM, a document management system account, a content management system account, etc.). At step 620, the user is prompted to submit biometric data (e.g., digital photographs, fingerprint scans, iris scans, etc.) that will be used during subsequent accesses of the information handling system as previously shown in FIG. 4. In one embodiment, a single user is associated with an account, while in an alternative embodiment, more than one person can be associated with an account. For example, in a banking scenario where a husband and wife share a joint account, biometric data corresponding to both the husband and the wife (e.g., digital photographs of each) would be associated with the account. In this alternative embodiment, if one of the associated users (e.g., the husband) logs onto the bank account (e.g., at an ATM, etc.) and steps away from the system and then another associated user (e.g., the wife) appears before the system, the biometric data for either associated user (e.g., the husband or the wife) would satisfy the continual verification process shown in FIG. 4. However, if neither associated user appears before the system and, instead a third party (e.g., a malevolent user, thief, etc.) appears before the system, the biometric data of the third party would not satisfy the continual verification process and access of the system (e.g., the ATM, etc.) would be suspended and/or terminated.

At step 630, biometric data is received from one or more users that is associated with the account, such as by using digital camera 310. At step 640, the received biometric input (e.g., the digital images, images of provided fingerprint, etc.) are digitized and stored in data store 330 as digital images. At step 650, the biometric data that will be used during the verification process (the expected biometric data) is identified from the biometric digital input received at step 630. At step 660, the expected biometric data is stored in data store 330 for future retrieval and use during subsequent verification processing shown in FIG. 4.

A decision is made as to whether there are more users to associate with the account (decision 670), such as a husband/wife as described in the previous example. If there are more users to associate with this account, then decision 670 branches to the “yes” branch which loops back to receive and process the next set of biometric input (e.g., digital facial images) from the next user of the account. This looping continues until there are no more users to associate with the account, at which point decision 670 branches to the “no” branch whereupon setup processing ends at 695.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A processor-implemented method comprising:
establishing an authorized user identity at an information handling system that includes the processor;
permitting a user access to the information handling system, wherein the user corresponds to the authorized user identity;
retrieving expected biometric data from a data store, wherein the expected biometric data corresponds to the authorized user identity;
following the permitting of access, repeatedly:
receiving a biometric input at a biometric receiver accessible from the information handling system, wherein the received biometric input corresponds to a current user of the information handling system;
generating current biometric data based on the received biometric input;
comparing the current biometric data to the expected biometric data;
determining whether the authorized user identity corresponds to the current biometric data based on the comparison;
allowing continued access to the information handling system in response to the determination being that the current biometric data corresponds to the authorized user identity; and
inhibiting access to the information handling system in response to the determination being a mismatch between the current biometric data and the authorized user identity.

2. The method of claim 1 wherein the biometric input is a facial image received from a digital camera.

3. The method of claim 2 further comprising:
in response to determining that the current biometric data corresponds to the authorized user identity:
comparing a current facial image corresponding to the current biometric data to a previously stored facial image stored in a memory, wherein the previously stored facial image was stored in the memory after the permitting;
identifying the current facial image is a still image based on the comparison; and
inhibiting access to the information handling system in response to the identification of the still image.

4. The method of claim 2 further comprising:
in response to the determination being a mismatch between the current biometric data and the authorized user identity:
recording data to a nonvolatile memory, wherein the recorded data includes a timestamp, the authorized user identity, and the facial image taken by the digital camera.

5. The method of claim 1 further comprising:
after inhibiting access to the information handling system, repeatedly:
receiving the biometric input at the biometric receiver;
generating the current biometric data based on the received biometric input;
comparing the current biometric data to the expected biometric data;
determining whether the authorized user identity corresponds to the current biometric data based on the comparison;
resuming access to the information handling system in response to the determination being that the current biometric data corresponds to the authorized user identity; and
continuing to inhibit access to the information handling system in response to the determination being a mismatch between the current biometric data and the authorized user identity.

6. The method of claim 5 further comprising:
identifying a time duration of the continuing inhibiting of access to the information handling system;
retrieving a time limit from a memory;
comparing the time duration to the time limit; and
terminating the user access to the information handling system in response to the identified time duration exceeding the time limit.

7. The method of claim 1 wherein the biometric input is selected from a group consisting of a facial image, a fingerprint image, and an iris scan image.

8. An information handling system comprising:
one or more processors;
a memory coupled to at least one of the processors;
a set of instructions stored in the memory and executed by at least one of the processors in order to perform actions of:
establishing an authorized user identity;
permitting a user access to the information handling system, wherein the user corresponds to the authorized user identity;
retrieving expected biometric data from a data store, wherein the expected biometric data corresponds to the authorized user identity;
following the permitting of access, repeatedly:
receiving a biometric input at a biometric receiver accessible from the information handling system, wherein the received biometric input corresponds to a current user of the information handling system;
generating current biometric data based on the received biometric input;
comparing the current biometric data to the expected biometric data;
determining whether the authorized user identity corresponds to the current biometric data based on the comparison;
allowing continued access to the information handling system in response to the determination being that the current biometric data corresponds to the authorized user identity; and
inhibiting access to the information handling system in response to the determination being a mismatch between the current biometric data and the authorized user identity.

9. The information handling system of claim 8 wherein the biometric input is a facial image received from a digital camera accessible from the information handling system.

10. The information handling system of claim 9 wherein the processors perform further actions comprising:
in response to determining that the current biometric data corresponds to the authorized user identity:
comparing a current facial image corresponding to the current biometric data to a previously stored facial image stored in a memory, wherein the previously stored facial image was stored in the memory after the permitting;
identifying the current facial image is a still image based on the comparison; and
inhibiting access to the information handling system in response to the identification of the still image.

11. The information handling system of claim 9 wherein the processors perform further actions comprising:
in response to the determination being a mismatch between the current biometric data and the authorized user identity:
recording data to a nonvolatile memory, wherein the recorded data includes a timestamp, the authorized user identity, and the facial image taken by the digital camera.

12. The information handling system of claim 8 wherein the processors perform further actions comprising:
after inhibiting access to the information handling system, repeatedly:
receiving the biometric input at the biometric receiver;
generating the current biometric data based on the received biometric input;
comparing the current biometric data to the expected biometric data;
determining whether the authorized user identity corresponds to the current biometric data based on the comparison;
resuming access to the information handling system in response to the determination being that the current biometric data corresponds to the authorized user identity; and
continuing to inhibit access to the information handling system in response to the determination being a mismatch between the current biometric data and the authorized user identity.

13. The information handling system of claim 12 wherein the processors perform further actions comprising:
identifying a time duration of the continuing inhibiting of access to the information handling system;
retrieving a time limit from a memory;
comparing the time duration to the time limit; and
terminating the user access to the information handling system in response to the identified time duration exceeding the time limit.

14. The information handling system of claim 8 wherein the biometric input is selected from a group consisting of a facial image, a fingerprint image, and an iris scan image.

15. A computer program product stored in a computer readable medium, comprising functional descriptive material that, when executed by an information handling system, causes the information handling system to perform actions that include:
establishing an authorized user identity at the information handling system;
permitting a user access to the information handling system, wherein the user corresponds to the authorized user identity;
retrieving expected biometric data from a data store, wherein the expected biometric data corresponds to the authorized user identity;
following the permitting of access, repeatedly:
receiving a biometric input at a biometric receiver accessible from the information handling system, wherein the received biometric input corresponds to a current user of the information handling system;
generating current biometric data based on the received biometric input;
comparing the current biometric data to the expected biometric data;
determining whether the authorized user identity corresponds to the current biometric data based on the comparison;
allowing continued access to the information handling system in response to the determination being that the current biometric data corresponds to the authorized user identity; and
inhibiting access to the information handling system in response to the determination being a mismatch between the current biometric data and the authorized user identity.

16. The computer program product of claim 15 wherein the biometric input is a facial image received from a digital camera.

17. The computer program product of claim 16 wherein the actions further comprise:
in response to determining that the current biometric data corresponds to the authorized user identity:
comparing a current facial image corresponding to the current biometric data to a previously stored facial image stored in a memory, wherein the previously stored facial image was stored in the memory after the permitting;
identifying the current facial image is a still image based on the comparison; and
inhibiting access to the information handling system in response to the identification of the still image.

18. The computer program product of claim 16 wherein the actions further comprise:
in response to the determination being a mismatch between the current biometric data and the authorized user identity:
recording data to a nonvolatile memory, wherein the recorded data includes a timestamp, the authorized user identity, and the facial image taken by the digital camera.

19. The computer program product of claim 15 wherein the actions further comprise:
after inhibiting access to the information handling system, repeatedly:
receiving the biometric input at the biometric receiver;
generating the current biometric data based on the received biometric input;
comparing the current biometric data to the expected biometric data;
determining whether the authorized user identity corresponds to the current biometric data based on the comparison;
resuming access to the information handling system in response to the determination being that the current biometric data corresponds to the authorized user identity; and
continuing to inhibit access to the information handling system in response to the determination being a mismatch between the current biometric data and the authorized user identity.

20. The computer program product of claim 19 wherein the actions further comprise:
identifying a time duration of the continuing inhibiting of access to the information handling system;
retrieving a time limit from a memory;
comparing the time duration to the time limit; and
terminating the user access to the information handling system in response to the identified time duration exceeding the time limit.
